(19) United States
(12) Patent Application Publication
(10) Pub. No.: US 2017/0053483 A1
(43) Pub. Date: Feb. 23, 2017

(54) GAMING MACHINE WITH MODULAR THEMATIC ELEMENTS

(71) Applicants: Milo Borissov, Dubai Sports City (AE); Rossi McKee, Indianapolis, IN (US)

(72) Inventors: Milo Borissov, Dubai Sports City (AE); Rossi McKee, Indianapolis, IN (US)

(21) Appl. No.: 15/238,868

(22) Filed: Aug. 17, 2016

Related U.S. Application Data
(60) Provisional application No. 62/207,298, filed on Aug. 19, 2015.

(51) Int. Cl. G07F 17/32

(52) U.S. Cl. CPC G07F 17/3216; G07F 17/3211; G07F 17/3246; G07F 17/3209; G07F 17/3251; G07F 17/3225

(57) ABSTRACT

A gaming machine comprises a gaming device and one or more modular thematic elements. The gaming device includes a housing, at least one display device, a game controller and one or more input devices. A thematic element may be located at a front of the gaming device to comprise a front of the gaming machine and/or be located at a rear of the gaming device to comprise a rear of the gaming machine. The one or more thematic elements may be selectively connected to and disconnected from the gaming device, such as by use of connectors, thus allowing them to be interchanged to change a theme or appearance of the gaming machine.

### RELATED APPLICATION DATA

This application claims priority to U.S. application Ser. No. 62/207,298, filed Aug. 19, 2015.

### BACKGROUND

The disclosed embodiments relate to gaming devices. More specifically, the disclosed embodiments relate to modular thematic elements for gaming devices.

Gaming machines utilized to present wagering games have been developed in a wide variety of configurations. The most common gaming machine configuration is the “upright” machine. This machine comprises a housing which has a front which faces the player. Towards the top is generally located one spinning reels or a video display. Below that is located one or more player buttons. At the bottom of the machine is generally located a coin tray into which winnings may be dispensed. In this configuration, the upright machine is a fully assembled single unit.

Generally, the machine is initially manufactured to present a particular game or suite of games. The gaming machine is thus manufactured to have a particular aesthetic appearance which corresponds to the game(s) which the gaming machine is desired to present. Thus, a gaming machine which is being manufactured to present one or more “space” themed games is generally manufactured to have a particular appearance associated with that theme. On the other hand, a gaming machine which is being manufactured to present a game corresponding to a particular TV show is generally manufactured to have a particular appearance associated with that show. This forces the manufacturer to make each gaming machine different during the manufacturing process by using different components or elements to make the gaming machine. This increases the cost of manufacture.

In addition, modern gaming machines may be programmed to present a wide variety of games. With the advent of touch screen displays and computer controlled outcomes, it is possible to use a single machine to present many different types of games. Furthermore, by replacing, upgrading, or otherwise modifying the controller portion of the gaming machine, the games presented at the machine may be changed, upgraded, or replaced over time.

Thus, while the gaming machine is able to present different games via the display, it is difficult and expensive to replace or update gaming machine glass or other artwork or exterior elements which may be unique to one game to change the appearance and/or designations on the machine to attract customers to play new or upgraded games on the gaming machine. This is even more difficult where a gaming machine housing includes thematic elements corresponding to games offered at the gaming machine.

### SUMMARY

The disclosed embodiments have been developed in light of the above and aspects of the invention may include a gaming machine having modular thematic elements.

In one embodiment, the gaming machine comprises a gaming device and at least one modular thematic element. The gaming device includes a housing, at least one display device, a game controller, and one or more input devices. A thematic element may be located at a front of the gaming device to comprise a front of the gaming machine and/or be located at a rear of the gaming device to comprise a rear of the gaming machine. The one or more thematic elements may be selectively connected to and disconnected from the gaming device or one another, such as by use of connectors, thus allowing them to be interchanged to change a theme or appearance of the gaming machine.

In one embodiment, the gaming device may further have a platform on which the gaming device is disposed and a seat. The platform may comprise a track that is configured to adjust a distance between the seat and the front of the housing of the gaming device. A thematic element may be located at the front of the platform and/or rear of the platform to cause the gaming machine to have a particular thematic appearance.

In another embodiment, the second or rear thematic element may further comprise a seat that faces the front of the gaming device.

In some embodiments, a first thematic element is connected to a gaming device via first and second connectors or connection devices and a second thematic element is connected to the gaming device via third and fourth connectors or connection devices. The first, second, third, and fourth connectors or connection devices may comprise fasteners. In still other embodiments, the first, second, third, and fourth connectors or connection devices may comprise clamping devices, clips, or other suitable connectors. Preferably, the connectors and/or connection devices permit the thematic elements to be coupled to otherwise selectively associated with a gaming device and de-coupled or disassociated from a gaming device, thereby allowing the appearance of the gaming machine to be changed.

Further objects, features, and advantages of the present invention over the prior art will become apparent from the detailed description of the drawings which follows, when considered with the attached figures.

### BRIEF DESCRIPTION OF THE DRAWINGS

FIG. 1 shows a gaming machine according to one exemplary embodiment.

FIG. 2 shows a gaming machine with modular thematic elements according to one exemplary embodiment.

FIG. 3 shows the gaming machine and modular thematic elements of FIG. 2 in an unassembled state, according to one exemplary embodiment.

FIG. 4 shows a gaming machine with alternate modular thematic elements according to one exemplary embodiment.

FIG. 5 shows the gaming machine with the alternate modular thematic elements of FIG. 5 in an unassembled state, according to one exemplary embodiment.

FIG. 6A, FIG. 6B, FIG. 6C, and FIG. 6D show a gaming machine with various modular thematic elements, according to exemplary embodiments.

### DETAILED DESCRIPTION OF EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the disclosed embodiments relate to gaming machines. In one embodiment, the gaming machine is modular, having a gaming device portion and one or more thematic element portions. The gaming device portion may be mated with different thematic element portions. The thematic element portions may have a variety of different configurations. In one embodiment, the gaming device and a mating thematic element portion need not be physically connected. The gaming device, such as a casino gaming machine, also may have various configurations.

A gaming machine of the invention may be located at a casino (and as such may be referred to as a “casino gaming machine”). As described below, the gaming machine may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

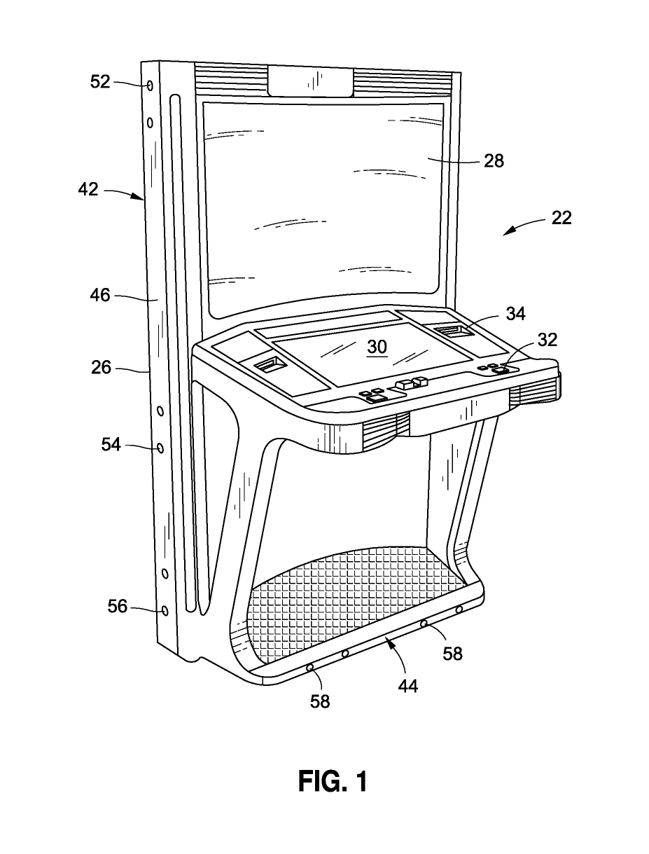

As indicated, in one embodiment a gaming machine of the invention includes a gaming device or gaming device portion 22. One configuration of a gaming device 22 is illustrated in FIG. 1. As illustrated, the gaming device 22 generally comprises a housing or cabinet 26 for supporting and/or enclosing various components required for operation of the gaming device. The configuration of the gaming device 22 may vary. In the embodiment illustrated, the gaming device 22 has an “upright” configuration in which a main display (described below) is generally vertically oriented. However, the gaming device 22 could have other configurations, shapes or dimensions (such as being of a “slant”-type, “bar-top” or other configuration as is well known to those of skill in the art).

The gaming device 22 preferably includes at least one display device 28 configured to display game information. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 28 may be capable of projecting or displaying a wide variety of information, including images, symbols and other indicia or information associated with game play, game promotion or other events. In the disclosed embodiment, the display device is curved about a vertical axis to enhance the overall gaming experience by allowing the game player to feel enveloped by the game display 28.

The gaming device 22 might include more than one display device 28, such as two or more displays 28 which are associated with the housing 26. The gaming device 22 might also include a top box or other portion. Such a top box might include one or more display devices 28, such as in addition to one or more main displays which are associated with the housing 26. Also, the gaming device 22 might include side displays (such as mounted to the exterior of the housing 26) and might include multiple displays of differing sizes.

As described in more detail below, the gaming device 22 is preferably configured to present one or more games upon a player making a monetary payment or wager. In this regard, as described in more detail below, the gaming device 22 includes mechanism or means for accepting monetary value.

In one embodiment, certain game outcomes (but preferably not all game outcomes) may be designated as winning outcomes (the non-winning outcomes may be referred to as losing outcomes). Prizes or awards may be provided for winning outcomes, such as monetary payments (or representations thereof, such as prize of credits), or promotional awards as detailed herein. As detailed below, the gaming device 22 preferably includes a mechanism or means for returning unused monetary funds and/or dispensing winnings to a player.

The gaming device 22 preferably includes one or more player input devices 30 (such as input buttons, plunger mechanisms, a touch-screen display, joystick, touch-pad or the like). These one or more devices 30 may be utilized by the player to facilitate game play, such as by providing input or instruction to the gaming device 22. For example, such input devices 30 may be utilized by a player to place a wager, cause the gaming device 22 to initiate a game, to indicate cards to be held or discarded, to “cash out” of the gaming machine, or to provide various other inputs.

In one preferred embodiment, the gaming device 22 includes at least one microprocessor or controller for controlling the gaming machine, including receiving player input and sending output signals for controlling the various components or peripheral devices of the machine 22 (such as generating game information for display by the display 28). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 28, for determining winning or losing game outcomes and for displaying information regarding awards for winning game outcomes, among other things.

The controller may be configured to execute machine readable code or “software” or otherwise process information, such as obtained from a remote server. Software or other instructions may be stored at a memory or data storage device, e.g. in a fixed or non-transitory configuration. The memory may also store other information, such as pay table information. The gaming device 22 may also include one or more random number generators for generating random numbers, such as for use in selecting slot symbols, cards or other game symbols (depending on the game being presented) and for presenting the game in a random fashion (e.g. whereby the game is presented in a manner in which the player cannot control the outcome) or pseudo-random fashion (e.g. such as where the game includes a skill component which can affect the outcome of the game).

Preferably, the controller is configured to execute machine readable code or instructions which are configured to implement the game. In this regard, the gaming machine is specially configured to present the game of the invention via specific software and/or hardware which causes the gaming machine to operate uniquely. For example, the controller of the gaming device 22 may be configured to detect a wager, such as a signal from a player's depressing of the “bet one” button. Upon such an event and/or the player otherwise signaling the gaming machine to present the game, the controller may be configured to cause the at least one display 28 to display unique information, such as a unique graphical interface or unique game display, including game symbols or other game information. The controller may accept input from a player of game inputs, such as a request to spin reels or the like, via the one or more player input devices of the gaming device 22. It will be appreciated that the machine readable code may be configured in various manners, such as by having various “modules” of software which are designed to implement specific features of the game play or game presentation.

The gaming device 22 may be configured to generate and present games in a stand-alone manner or it may be in communication with one or more external devices at one or more times. For example, the gaming device 22 may be configured as a server based device and obtain game code or game outcome information from a remote game server (in which event the gaming machine controller may receive game information from the server, such as game outcome information, and use that server-generated information to present the game at the gaming machine).

As indicated, the gaming device 22 is configured to present one or more wagering games. The gaming machines 22 is preferably configured to accept value, such as in the form of coins, tokens, paper currency or other elements or devices representing value such as monetary funds. Thus, as indicated above, the gaming device 22 preferably includes a mechanism or means for accepting monetary value. For example, as illustrated in FIG. 1, the gaming device 22 might include a coin acceptor 32 for accepting coins. Of course, associated coin reading/verifying devices and coin storage devices may be associated with the gaming device 22 if it is configured to accept coins. Likewise, the gaming device 22 might include a media reader 34. Such a reader may be configured to accept and read/verify paper currency and/or other media such as tickets. Of course, in such event the gaming device 22 may further be configured with one or more paper currency or ticket storage devices, such as cash boxes, and other paper currency or media handling devices (including transport devices).

The gaming device 22 might also be configured to read FOB s, magnetic stripe cards or other media having data associated therewith and via which value or funds may be associated with the gaming device 22. The mechanism for accepting monetary value might also comprise hardware and/or software which allows a player to transfer (such as electronically) funds from an account, such as a casino wagering account, or a bank or other financial institution account. Such a mechanism might include a communication interface which permits the gaming machine to communicate with a mobile phone, PDA, tablet or other electronic device of the player (such as via a physical interface or wired or wireless communications, such as to enable the transfer of funds from the player to the gaming machine or system.

When the player associates funds with the gaming machine or an associated system, a credit balance is generated. The credit balance may comprise a plurality of monetary value credits. The player may wager some or all of the associated monetary value, such as by wagering one or more of the credits associated with the credit balance. For example, the player might provide input to a wager button or touch screen interface to wager a certain number of credits (such as “Bet 1 Credit”, “Bet 5 Credits”, “Bet Maximum Credits” or other options). In one embodiment, when the player's wager is received, the player's credit balance is reduced by the number of wagered credits. The player might then provide a separate input to begin the game. In other embodiment, the player might select a “play game” input, such as by pressing a “spin” button, which input is taken to comprise both an instruction to place a wager (such as of a pre-set or pre-selected number of credits) and to start the game. Of course, other configurations may be implemented for accepting monetary value from the player and for allowing the player to place a wager from the associated monetary value.

In one embodiment, the gaming device 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. These winnings may be associated with the player's credit balance, thus increasing the player's credit balance.

In one embodiment, the player may provide an input to the gaming device 22 to indicate their desire to cash out, such as by selecting a “cash out” button or touch screen feature or providing other input. In response, a monetary value represented by the player's credit balance or the like is preferably paid, transferred or otherwise provided to the player. For example, upon an award or at cash-out, associated funds may be paid to the player by the gaming device 22 dispensing coins to a coin tray. In another embodiment, funds may be issued by dispensing paper currency. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference. In yet another embodiment, the cash-out might result in the dispensing of a card or other media which stores or represents the cashed-out funds, such as by writing funds information to a magnetic stripe of a card which is inserted into a media writer of the gaming machine or dispensed from the machine. In other embodiments, the cash-out mechanism may result in the funds value being transferred to an external device or account, such as a player's casino account (such as associated with a casino server), a remote bank or other financial account, or an electronic device such as a player's phone, PDA or tablet.

The gaming device 22 may also include a player tracking device, such as a card reader 66 and associated keypad 70. Such player tracking devices are well known and may permit the game operator to track play of players of the gaming machine. The tracked play may be utilized to offer player bonuses or awards.

A casino may have numerous such gaming machines 22, such as located on a casino floor or in other locations. Of course, such gaming machines 22 might be used in other environments, such as an airport, a bar or tavern or other locations.

The gaming device 22 may, as noted above, be part of a system which includes other devices. For example, the gaming device 22 may communicate with one or more casino systems, such as a player tracking server or system, an accounting system or server, a ticketing system, a bonusing system, a tournament system, other gaming machines, and external devices.

As explained above, the gaming device 22 may be configured internally to present a number of different games. It is desirable for the gaming device to include various aesthetic features which attract players to the gaming device. The aesthetic features may, for example, provide a visual presentation consistent with a theme of a game which the gaming device presents (which game(s) may also change from time to time). Accordingly, one embodiment of gaming machine of the invention comprises a gaming device having one or more modular, replaceable thematic elements attached thereto. For example, the gaming machine of the invention may have a thematic element attached to or located at a front side 44 of the gaming device 22 (the side to which the display 28 faces), and/or may have a thematic element attached to or located at the rear side 42 of the gaming device 22. In such a configuration, a front thematic element forms a front of the gaming machine and a rear thematic element forms a rear of the gaming machine (e.g. the gaming device is located behind the front thematic element, in front of the rear thematic element, or between the thematic elements when the gaming machine includes both front and rear elements).

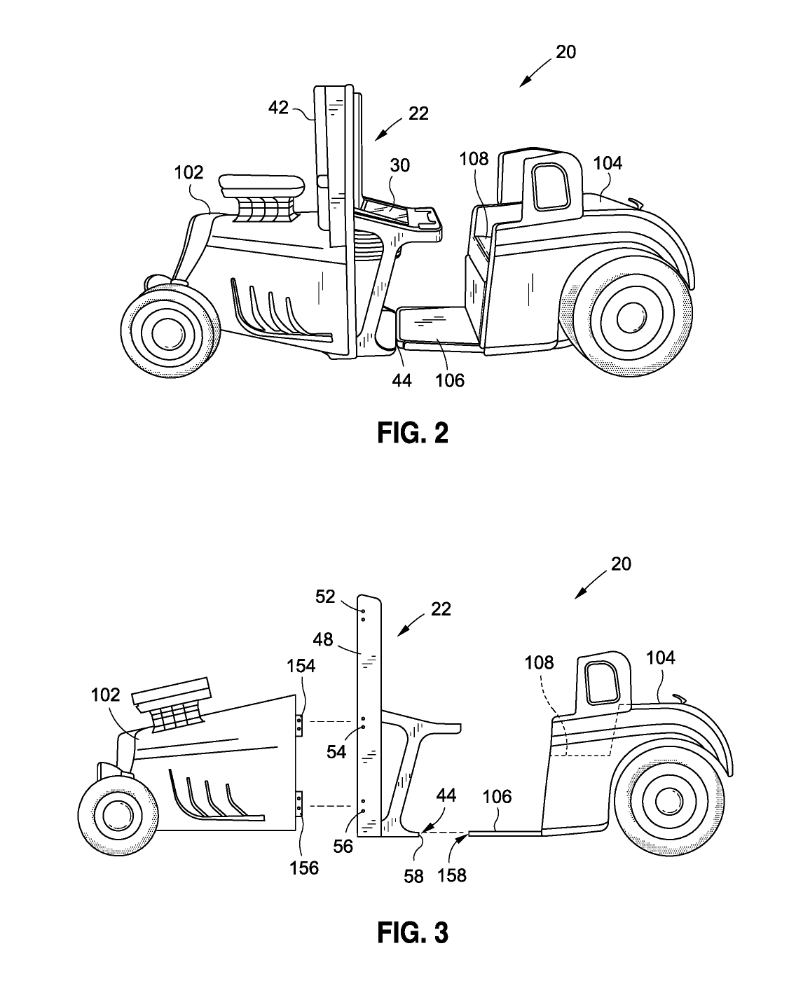

For example, FIG. 2 shows a gaming machine 20 with modular thematic elements attached to or associated with a gaming device 22 according to one exemplary embodiment. Specifically, a first thematic element 102 is attached to the rear side 42 of the gaming device 22 and a second thematic element 104 is attached to the front side of the gaming device 22. The thematic elements 102, 104 include a housing, body or combinations of elements constructed to resemble a predetermined theme or motif. In this embodiment, the thematic elements 102, 104 are configured so as to resemble a hot rod. The thematic element 104 in this embodiment that attaches to the front 44 of the gaming device 22 may include a seat 108 and a foot rest 106. In this embodiment, the player may be able to sit in the hot rod on the seat 108 and place his or her foot on the foot rest 106.

FIG. 3 shows the gaming machine with modular thematic elements of FIG. 2 in an unassembled configuration, according to one exemplary embodiment. The thematic elements 102, 104 may be configured to be connectable to or otherwise be associated with the gaming device 22 in any number of suitable manners. In a preferred embodiment, the thematic elements 102, 104 are modules which are configured to be selectively attached to the gaming device 22 and detached from the gaming device 22, thus permitting them to be readily interchanged (however, they might be semi-permanently connected thereto).

As such, in one embodiment connection means are provided between the thematic elements 102, 104 and the gaming device 22, such as one or more first connectors or connection elements associated with the gaming device and one or more second connectors or connection elements associated with each thematic elements, which first and second connectors are designed for mating connection and disconnection.

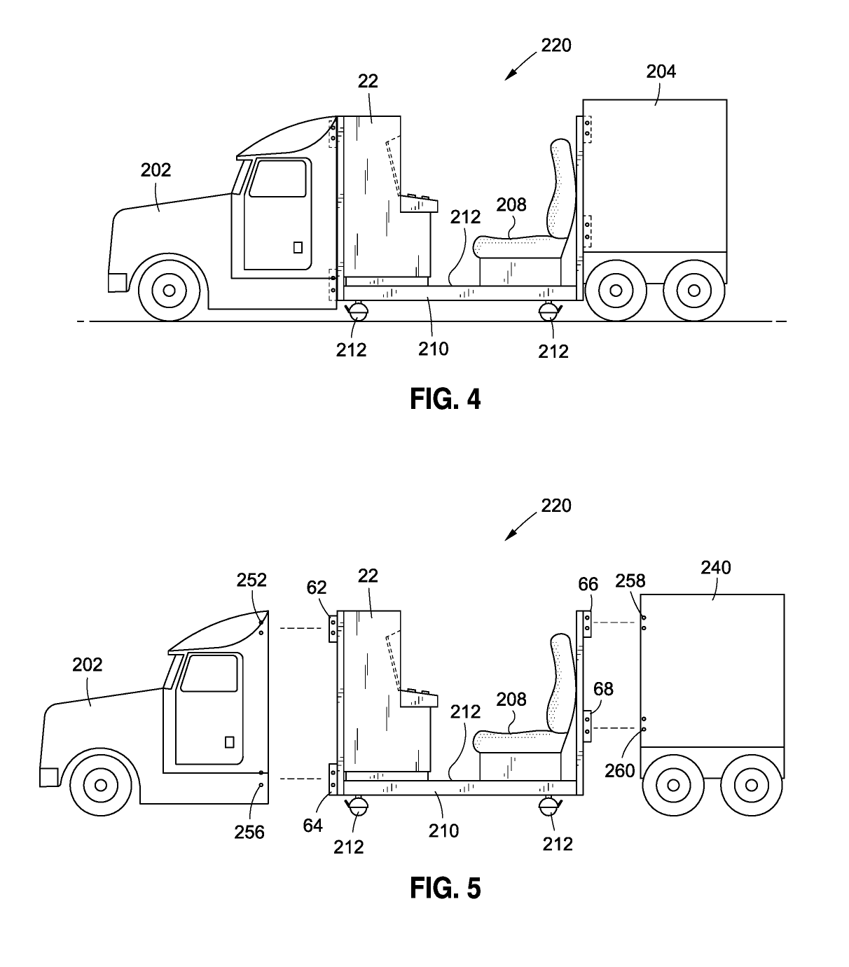

In other embodiments, the thematic elements might be associated with a gaming device in other manners. For example, as described in more detail below, as illustrated in FIG. 4, the gaming device 22 might be configured to that it is positioned between a front and rear thematic element, wherein the front and rear thematic elements are selectively connected to one other (such as by straps, bars or other connectors which might extend under the gaming device, etc.), whereby the gaming device is positioned between the front and rear thematic elements (or at least behind a front thematic element or in front of a rear thematic element).

For example, the gaming device 22 may comprise a number of protrusions 52, 54, 56 along a side wall 46 thereof. The thematic element 102 may have clips 154, 156 at heights to match one or more of the protrusions 52, 54, 56 and to clip over and/or onto the protrusions 52, 54, 56. Other suitable connections may also be used such as fasteners, clamping devices, and the like.

Similarly, protrusions 58 may be disposed on the front 44 of the gaming device 22 to couple with clips, fasteners or clamps 158 on the second thematic element 104 to connect the second thematic element 104 to the gaming device 22. In this manner, both thematic elements 102, 104 may easily attach to the front 44 and the rear 46 of the gaming device 22. Furthermore, by the use of non-permanent connections, the thematic elements 102, 104 may also be easily removed or detached from the gaming device 22 and be replaced with different thematic elements.

Another such embodiment is shown in FIG. 4. FIG. 4 shows a gaming machine 220 with modular thematic elements according to a second exemplary embodiment. In FIG. 4, the gaming device 22 is attached to a first thematic modular element 202 and a second modular thematic element 204. In this instance, the thematic elements 202, 204 are configured to resemble portions of a semi-truck.

FIG. 4 also shows a different configuration of a gaming device 22. In the embodiment shown in FIG. 4, the gaming device portion of the gaming machine comprises the gaming device 22 and a seat 208 which are coupled to form a unit, such as by mounting upon a platform 210. The platform 210 may be supported by castors 212, feet, or the like. For example, when a gaming machine 20, 220 has large thematic elements as described herein, the gaming machine may be a marquee gaming machine to attract game players not only to the machine with the thematic elements, but also to a bank of gaming machines offering similar games nearby. Thus, the gaming machine may need to be easily, strategically positioned on the floor to generate the most excitement about the game(s) as possible. Thus, the gaming machine may be configured to be easily moved.

The top surface 212 of the platform 210 may comprise a track (not shown) on which the seat 208 may be adjusted. That is, the seat 208 may be moved further or closer to the gaming machine 22 to provide for the comfort of the player. As shown in FIG. 5, in this embodiment, the platform 210 includes connections 62, 64 that extend from the rear of the gaming device 22 and connections 66, 68 from the rear of the seat 208. The connections 62, 64, 66, 68 may be any number of connecting devices including protrusions, holes to receive fasteners, clamping devices, clips, etc. The connections 62, 64 are configured to couple with connections 252, 256 on the first thematic element 202. The connections 66, 68 are configured to couple with connections 258, 260 on the second thematic element 204.

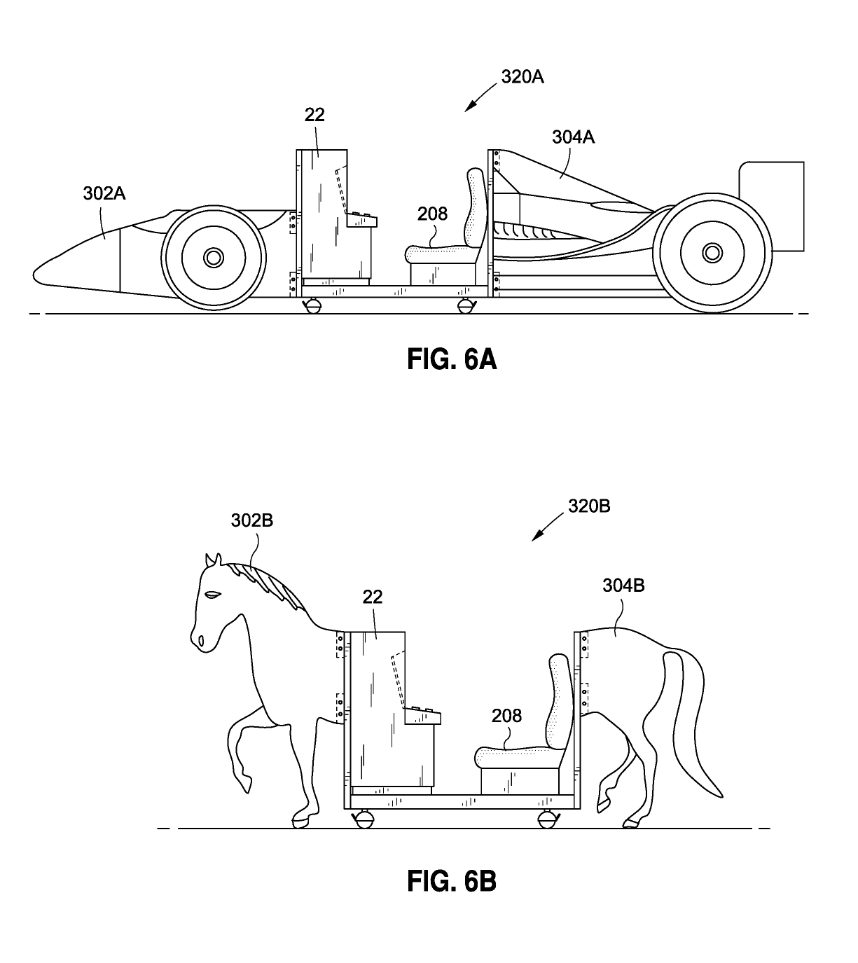

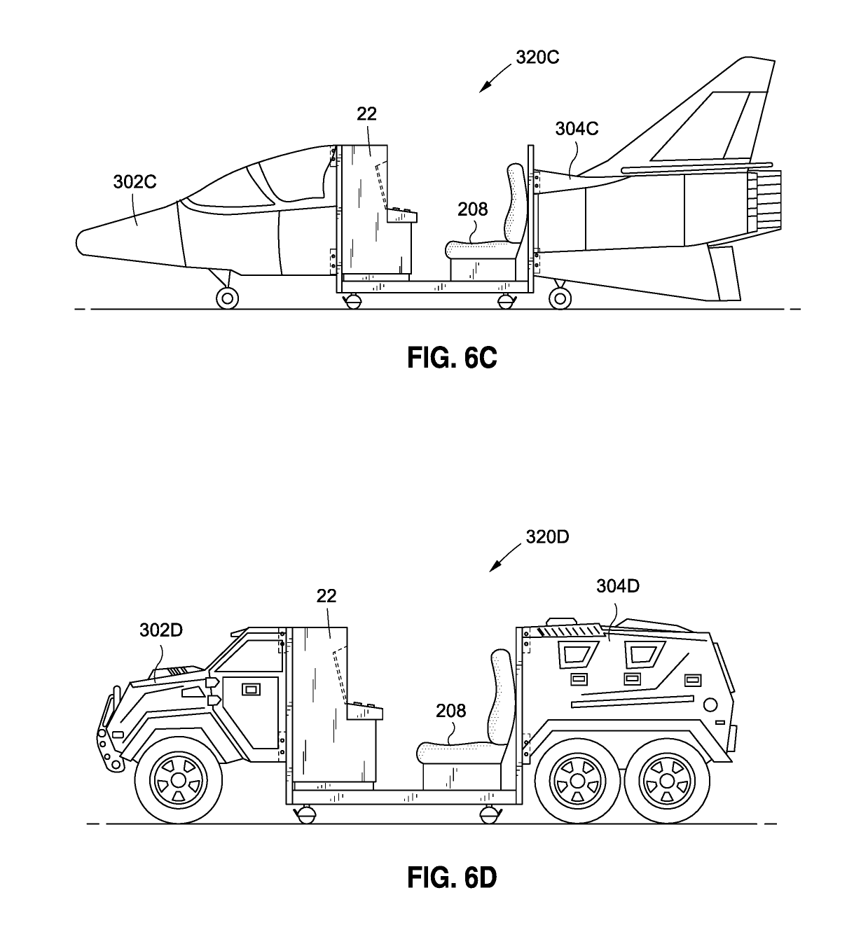

Other examples or modifications are also within the scope of the present invention, for example, FIGS. 6A-D show various embodiments of thematic elements which may be attached to the gaming device 22. In FIG. 6A, elements 302A and 304A allow the gaming machine 320A to have a race car theme. In FIG. 6B, elements 302B and 304B allow the gaming machine 320B to take on an equestrian theme. In FIG. 6C, elements 302C and 304C allow the gaming machine 320C to have an aviation theme. In FIG. 6D, elements 302D and 304D allow the gaming machine 320D to have a military vehicle theme. It is noted that while these embodiments are shown with the elements 304A-D attached to a seat 208, the elements 304A-D may also be attached to the front of the gaming device 22 as in FIGS. 2 and 3.

It is noted that the thematic elements shown in the above embodiments are exemplary, and further additional elements may be included. For example, where the elements take on a vehicular theme, a door, cockpit, or other similar element may be included that attaches to the front and the rear elements. Furthermore, the elements do not need to take on a transportation theme, but may include any other number of themes. For instance, the theme may be a medieval theme where the thematic elements make the gaming machine appear as part of a castle. In short, any number of possibilities for thematic elements are possible on a gaming machine using the above described embodiments.

The thematic elements or portions might also comprise or include other portions. For example, a front or rear thematic portion might also extend over all or a portion of the top of the gaming device and/or along one or both sides of the gaming device 22. Alternately, top and/or side or other thematic elements might be connected to the gaming device 22 and/or other thematic elements. This may allow, for example, the gaming machine illustrated in FIG. 2 to include “doors” at each side of the gaming machine, for the gaming machine illustrated in FIG. 6A to have a top over the “driver area”.

As indicated herein, the thematic elements of the invention may be constructed in various manners. In one embodiment, the thematic elements might comprise a superstructure or supporting frame which supports an outer shell or covering. In one embodiment, the thematic elements might be molded, such as from plastic. Of course, the thematic elements might have various configurations and be painted or include color, may include moving features, lights or other elements which relate to or enhance the intended theme for the gaming machine.

As indicated herein, while a gaming machine of the invention preferably comprises a gaming device to which is connected a front and a rear thematic element or portion, the gaming machine might have other configurations. For example, the gaming machine might comprise only a front thematic element or portion connected to a gaming device or just a rear thematic element or portion.

The invention has numerous benefits. First, during manufacture a standard gaming device may be manufactured, regardless of the desired end configuration of the gaming machine. In other words, the gaming device and its method/configuration of manufacture may be standardized. Yet, by associating different thematic elements or portions with each gaming device, gaming machines having different appearances, themes, etc. may be created. Further, the configuration of the gaming machine can easily be modified from time to time. For example, a gaming machine which has an “equestrian” theme might be changed to one having a “racing” theme by simply changing the thematic elements or portions.

It will thus be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming machine having modular thematic elements comprising:
a gaming device including a housing, at least one display device, at least one first connection device, and at least one second connection device, the housing having a front side and a rear side, the first connection device being disposed on or adjacent the rear side, and the second connection device being disposed on or adjacent the front side;
a first thematic element disposed on the rear side of the gaming device, the first thematic element comprising a housing constructed to a predetermined theme and a third connection device, the third connection device of the first thematic element releasably coupling to the first connection device on or adjacent to the rear side of the gaming device; and
a second thematic element disposed on the front side of the gaming device, the second thematic element comprising a housing constructed to the predetermined theme and a fourth connection device, the fourth connection device of the second thematic element releasably coupling to the second connection device on or adjacent to the front side of the gaming machine.

2. The gaming machine of claim 1, wherein the gaming device further comprises a platform on which the gaming device is disposed and a seat, the second connection device being disposed on or adjacent to a rear side of the seat.

3. The gaming machine of claim 2, wherein the platform comprises a track that is configured to adjust a distance between the seat and the front of the gaming device housing.

4. The gaming machine of claim 1, wherein the second thematic element further comprises a seat facing the front of the gaming device.

5. The gaming device of claim 1, wherein the at least one display device is curved.

6. The gaming device of claim 5, wherein the at least one display device is curved about a vertical axis.

7. The gaming device of claim 1, wherein the first, second, third, and fourth connection devices comprise fasteners.

8. The gaming device of claim 1, wherein the first, second, third, and fourth connection devices comprise clamping devices.

9. The gaming device of claim 1, wherein the first, second, third, and fourth connection devices comprise clips.

10. A method for modifying a theme for a gaming machine, the method comprising:
attaching a first modular thematic element to a gaming machine, the gaming machine comprising a housing, at least one display device, at least one first connection device, and at least one second connection device, the housing having a front side and a rear side, the first connection device being disposed on or adjacent the rear side, and the second connection device being disposed on or adjacent the front side, the first modular thematic element comprising a housing constructed to a predetermined theme and a third connection device, and the third connection device of the first thematic element releasably coupling to the first connection device on or adjacent to the rear side of the gaming device; and
attaching a second modular thematic element to the front side of the housing of the gaming machine, the second thematic element comprising a housing constructed to the predetermined theme and a fourth connection device, the fourth connection device of the second thematic element releasably coupling to the second connection device on or adjacent to the front side of the gaming machine.

11. The method of claim 10, wherein the gaming device further comprises a platform on which the gaming device is disposed and a seat, the second connection device being disposed on or adjacent to a rear side of the seat.

12. The method of claim 11, wherein the platform comprises a track that is configured to adjust a distance between the seat and the front of the gaming device housing.

13. The method of claim 10, wherein the second thematic element further comprises a seat facing the front of the gaming device.

14. The method of claim 10, wherein the at least one display device is curved.

15. The method of claim 14, wherein the at least one display device is curved about a vertical axis.

16. The method of claim 10, wherein the first and second modular thematic elements are attached to the rear and the front sides of the gaming machine using fasteners.

17. The method of claim 10, wherein the first and second modular thematic elements are attached to the rear and the front sides of the gaming machine using clamping devices.

18. The method of claim 10, wherein the first and second modular thematic elements are attached to the rear and the front sides of the gaming machine using clips.
